(19) United States
(12) Patent Application Publication
(10) Pub. No.: US 2024/0282295 A1
(43) Pub. Date: Aug. 22, 2024

(54) METHOD AND SYSTEM FOR TRAINING CLASSIFIERS FOR USE IN A VOICE RECOGNITION ASSISTANCE SYSTEM

(71) Applicant: HARMAN CONNECTED SERVICES, INC., Mountain View, CA (US)

(72) Inventor: Aleksandr Aleksandrovich BOROCHKIN, Nizhny Novgorod (RU)

(21) Appl. No.: 18/292,126

(22) PCT Filed: Jul. 28, 2021
(86) PCT No.: PCT/RU2021/000318

§ 371 Date: Jan. 25, 2024

(51) Int. Cl. G10L 15/18; G10L 15/26

(52) U.S. Cl. CPC G10L 15/18; G10L 15/26

(57) ABSTRACT

The disclosure relates to a method and system for training one or more classifiers for use in a voice recognition, VR, assistance system. The method comprises collecting data which contain one or more natural language queries to the VR assistance system; processing the data using a natural language processing, NLP, algorithm; generating a first classification output, based on the results of the NLP; obtaining a user input based on the first classification output; and generating a second classification output, based on the user input, for training the classifier.

### FIELD

The present disclosure relates to the training of classifiers of an artificial intelligence. In particular, the disclosure relates to methods and systems for training classifiers for use in a voice recognition assistance system.

### BACKGROUND

Voice recognition, VR, assistance systems are widely used in an increasing number of applications. The demands regarding the performance of VR systems with respect to language recognition, language use and content recognition are high. Users expect that VR assistance systems perform at a similar service level as human professionals at help desks or cabin steward employees. Thus, artificial intelligence, AI, systems and in particular the classifiers of the AI systems need to be trained in order to achieve service goals in different fields of applications.

A standard approach to evaluate the performance of VR assistance systems relies on technophile users and/or customer representatives who ask questions to the system in an environment close to system production and make personal judgments about the response correctness and software effectiveness. This approach is, however, based on conjectures and suppositions about real user intents and lacks objectivity.

The present disclosure provides a method and system for training classifiers for use in VR assistance systems. The disclosed approach allows for an objective, evidence-based training of classifiers by creating automated reports of a rating of a classification output, based on natural language processing, NLP, algorithms, and a user input.

### SUMMARY OF INVENTION

A first aspect of the present disclosure relates to a method for training one or more classifiers for use in a voice recognition, VR, assistance system. The method comprises:
collecting data which contain one or more natural language queries to the VR assistance system;
processing the data using a natural language processing, NLP, algorithm;
generating a first classification output, based on the results of the NLP;
obtaining a user input based on the first classification output; and
generating a second classification output, based on the user input, for training the classifier.

The objective of the method is to improve the classification of natural language queries to a VR system by NLP algorithms. The method allows for the evidence-based evaluation of the performance of VR assistance systems and training of the classifiers of the VR assistance system. To this end, collected data containing natural language queries to a VR assistance system are processed using NLP. Thereby, data are classified according to categories including audio quality, speech-to-text transcription quality, scope identification and/or answer appropriateness. A first classification output is generated based on the NLP. A second classification output is generated based on an obtained user input evaluating the NLP results. Based on this second classification output, the classifiers of an AI for use in a VR assistance system can be efficiently improved. In particular, distinctive functional errors such as problems with the query audio or wrong determination of the scope of the query may be identified. Correct classification of the scope and meaning of a query and resulting response appropriateness can be improved.

According to an embodiment, the VR assistance system may be a multi-language VR assistance system. Supported languages may include English, German, French and Spanish among others. Enabling the system to identify a multitude of languages broadens the field of applications, for example to include touristic environments.

According to an embodiment, the natural language processing, NLP, comprises the processing of audio data and speech-to-text transcribed data. Both, audio data and transcription data are analyzed using NLP algorithms. This may allow identifying the source of errors in content recognition or language recognition or similar.

According to another embodiment, the user input comprises an indication of an error of the NLP classification regarding the assignment of data to classes of language recognition and query content recognition.

Further, according to an embodiment, the user input comprises predefined labels for the evaluation of the first classification output. Using predefined labels improves efficiency of the rating process and enables reproducibility. The use of predefined labels further allows for automated subsequent processing of the user input.

In an embodiment, the first and second classification output comprise one or more of the natural language query, the language of the query, a data set comprising data which contain one or more of the complete query, a part of the query and the response of the VR assistance system to the query, an audio file transcript of the selected data set, information about audio errors within the selected data set, information about an accent of the speaker in a query, a profile of the speaker, classification of the scope of the query, classification of the scope of the answer by the VR assistance system given to the query.

Initial selection of the query language allows allocating or confirming subsequently used classifiers. The correct selection of the query language is a prerequisite of any further natural language processing. If it becomes apparent during this initial language check that the speaker uses a language different from the selected language of the VR assistance system, further analysis can be dismissed. Selecting a data set comprising data which contain a complete query or part of a query minimizes the amount of data that needs to be processed. Data selection is, therefore, crucial for the efficiency and speed of the NLP rating. Further, only relevant data is encrypted for analysis, thereby maintaining a high level of data security. Additionally, only data sets collected by one VR assistance system or one version of a VR assistance system are selected to ensure data consistency and avoid false analysis. Checking speech-to-text transcription and audio data for errors further narrows the data set which needs to be processed in more detail and thereby saves resources. In particular, speech-to-text transcription analysis is checked for mistakes in wording or grammar. Audio check comprises dismissing audio data of poor quality, for example with poor signal-to-noise ratio or poor volume. Adding information about the speaker accent and personal profile data, for example, age or gender, allows detecting biases of the system. Scope and content of the query and the answer of the VR assistance system are classified and rated regarding correctness and adequacy. This enables improving the VR assistance system knowledge base.

In an embodiment, the audio errors comprise errors regarding a wakeup word of the VR assistance system or errors regarding the query. Audio problems during activation of the VR assistance system using a wakeup word or phrase as well as audio errors during use of the VR assistance system are recognized and analyzed. Potential error sources may be identified.

Further, in an embodiment, the second classification output is generated based on a compute language script. This allows for subsequent, automated use of the results of the method to train the classifier.

A second aspect of this disclosure relates to a system for training one or more classifiers for use in a voice recognition, VR, assistance system. The system comprises a VR microphone and a computing device comprising an interface for a user input. The system is configured to execute the some or all of the steps of a method for training classifiers for use in a VR assistance system as described herein.

There is also provided a computer program product comprising a computer-readable storage medium including instructions that, when executed by a processor, cause the processor to perform some or all of the steps of the method described herein.

### BRIEF DESCRIPTION OF THE DRAWINGS

The features, objects, and advantages of the present disclosure will become more apparent from the detailed description set forth below when taken in conjunction with the drawings in which like reference numerals refer to similar elements.

FIG. 1 depicts a flow chart of a method 100 for training one or more classifiers for use in a voice recognition, VR, assistance system;

FIG. 2A-C depicts example classification outputs used in the method 100;

FIG. 3 depicts a block diagram of a system 200 for training one or more classifiers for use in a voice recognition, VR, assistance system.

### REFERENCE SIGNS

100 Method for training one or more classifiers for use in a voice recognition, VR, assistance system
102-110 Steps of method 100
300 System for training one or more classifiers for use in a voice recognition, VR, assistance system
302 Voice recognition microphone
304 Computing device

### DETAILED DESCRIPTION OF THE PREFERRED EMBODIMENTS

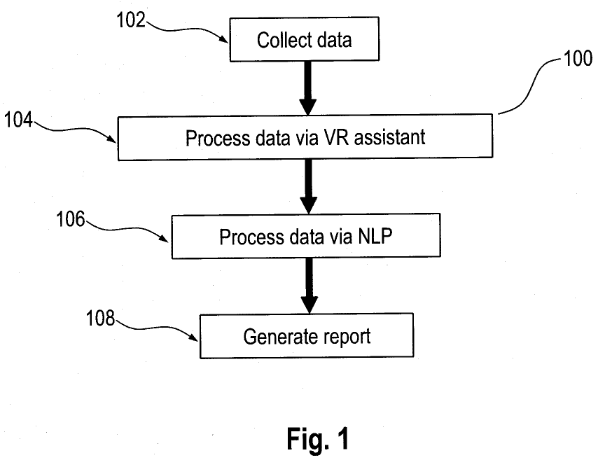

FIG. 1 depicts a flow chart of a method 100 for training one or more classifiers for use in a voice recognition, VR, assistance system. The method 100 comprises collecting data at step 102, comprise natural language query to a VR assistance system. In a preferred embodiment, the VR assistance system is a multi-language VR assistance system. The multi-language system may be configured to recognize queries in a multitude of languages, including, but not limited to, English, German, French or Spanish. Accordingly, the method 100 may comprise selecting a classifier according to the respective language for the following processing steps.

At step 104 the method 100 comprises processing data using natural language processing, NLP. All collected data may be analyzed. Analyzed data may include collected audio data and/or speech-to-text transcriptions of the collected audio data. In a preferred embodiment, a set of data is selected, which was collected by one VR assistance system or one version of a VR assistance system. Further, in a preferred embodiment, a part of the collected data is selected and analyzed. The selected part may contain natural language related to one query, for example a number of questions and answers exchanged between the speaker and the VR assistance system which relate to one topic. The selected part may alternatively contain one query or a part of a query. Selected data are process using the NLP algorithms. Processing may include one or more of indexing a query or a part of the query, extracting the location of the query collection, allocating an activation ID allowing to encrypt and encode the selected data, determining the device ID indicating the VR assistance system and its version, identifying the wakeup word used in the query to activate the VR assistance system, speech-to-text transcription, an automatic validation of the detection of the query and the scope of the query, identification of the answer of the VR assistance system to the query and an automatic validation of the answer.

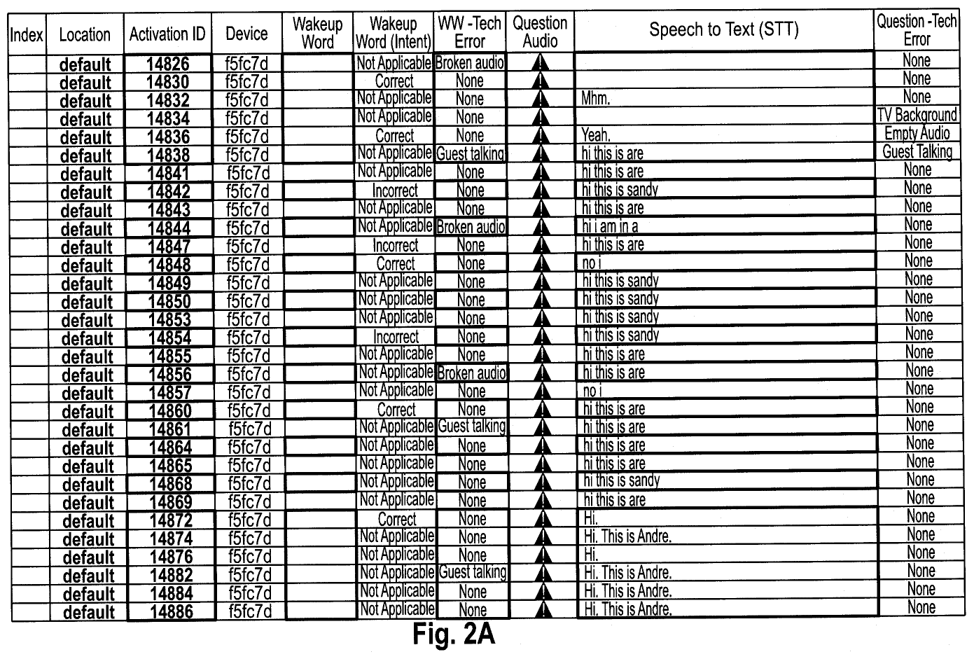

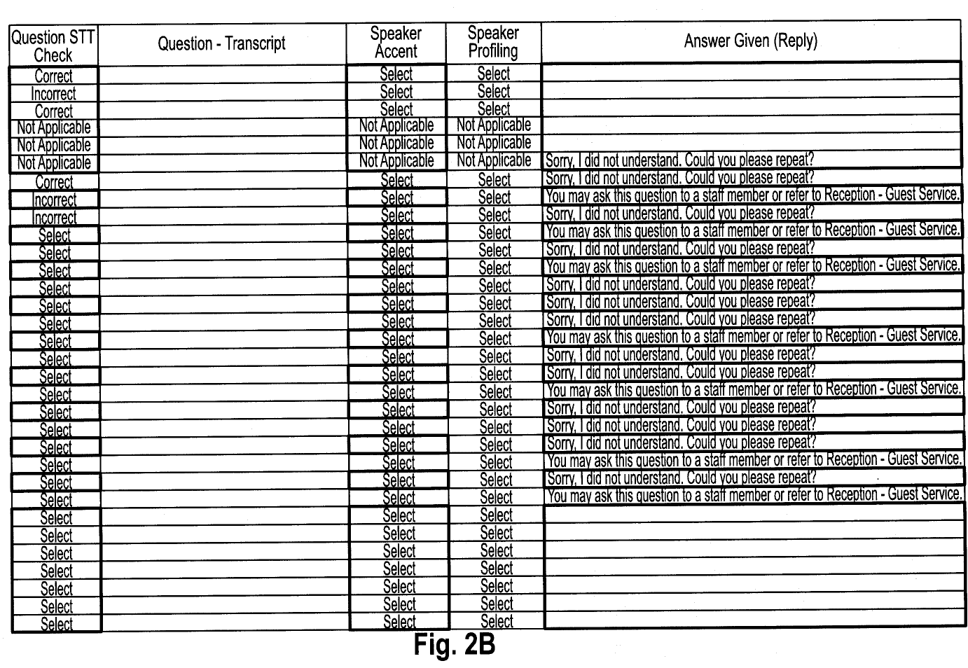

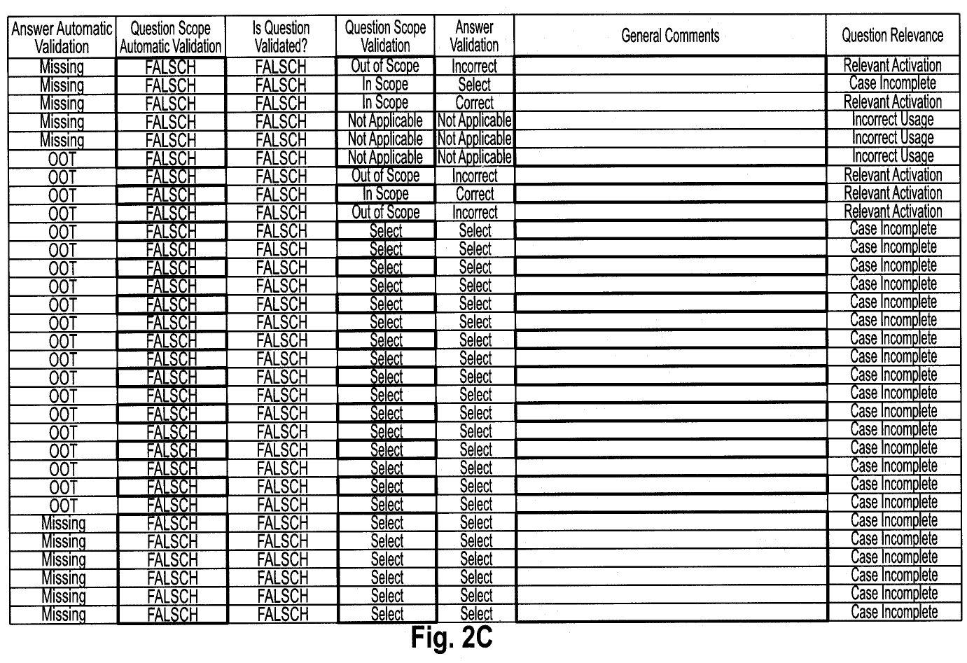

In step 106 of method 100, a first classification output including the results of the NLP processing is generated. The first classification output includes the categories of language of the query, selected data set, audio file transcript of the selected data set, information about audio errors within the selected data set, information about an accent of the speaker in a query, a profile of the speaker, classification of the scope of the query, and classification of the scope of the answer by the VR assistance system given to the query. An example classification output is shown in FIG. 2A-C.

In step 108 of method 100, a user input is obtained. The user input is based on the first classification output and further includes malfunction and error detection in one or more of the categories of the first classification output. The obtained user input may further comprise a speaker accent determination and a speaker profile.

In a preferred embodiment, the user input comprises information about audio errors within the analyzed data. Audio errors may comprise errors regarding a wakeup word for activating the VR assistance system or errors regarding the query of the speaker. Wakeup word errors may include use of a wrong word or an incomplete command. Technical audio errors may comprise broken audio (crackles or scrunches in the audio, while speaker voice may still be recognizable), guest talking (i.e. the speaker does not talk to the VR assistance system), background noises (background music, TV, or environmental noises) or empty audio (e.g. due to low volume). Audio errors regarding the query of the speaker may comprise, in addition to the above, incomplete questions, wrong language or multiple commands. An example user input is shown in FIG. 2A in columns “Wakeup word (Intent)”, “WW—Tech error” and “Question—Tech error”.

Further, errors might occur during audio file speech-to-text transcription. Such errors comprise wrong wording, misspelling or grammatical mistakes. The checking of the audio file transcript is positive, i.e. without detected error, if only equivalent transcriptions such as “okay” and “OK” are found or if audio transcription inconsistencies do not influence the correctness of the transcription.

The user input may further comprise question scope validation, answer classification and an indication of the query relevance to the application of the VR assistance system.

The user input on the above categories may be obtained in form of predefined labels for each category. Exemplary labels for the categories “Wakeup word detection”, “Query transcription check” or “Answer classification” may comprise “not applicable”, “correct” and “incorrect”. Labels for other categories may be predefined as shown in Table 1 and in Examples in FIG. 2A-C.

TABLE 1
Exemplary predefined labels for example categories
for use in second classification output

| | | Speaker | | | |
|---|---|---|---|---|---|
| Wakeup | Query | accent | Speaker | Question | Question |
| tech error | tech error | (English) | Profile | Scope | relevance |
| Not | Not | British | Male- | In Scope | Case |
| applicable | applicable | Eng. | Young | | in- |
| | | | | | complete |
| None | None | American | Male- | Out of | Incorrect |
| | | Eng. | Old | Scope | Usage |
| Broken | Broken | Canadian | Female- | Out of | Relevant |
| audio | audio | Eng. | Young | Knowl- | activation |
| | | | | edge | |
| Guest | Guest | Australian | Female- | Not | |
| talking | talking | Eng. | Old | applicable | |
| TV | TV | Indian | Child | | |
| background | background | Eng. | | | |
| Background | Background | Scottish | Other | | |
| music | music | Eng. | | | |
| Environment | Environment | Irish Eng. | | | |
| noises | noises | | | | |
| Empty audio | Empty audio | Others | | | |
| other | other | | | | |
| | Incomplete | | | | |
| | question | | | | |
| | Wrong | | | | |
| | language | | | | |
| | Multiple | | | | |
| | commands | | | | |

In step 110 of method 100, a second classification output including the user input is generated. The second classification output includes one or more of the categories of language of the query, selected data set, audio file transcript of the selected data set, information about audio errors within the selected data set, information about an accent of the speaker in a query, a profile of the speaker, classification of the scope of the query, and classification of the scope of the answer by the VR assistance system given to the query. Example user input is shown in FIG. 2B-C, for instance in columns “speaker accent”, “speaker profiling”, “question scope validation” or “answer validation”. In a preferred embodiment, the second classification output is generated based on a compute language script. The second classification output may be used for the training of the classifiers of an artificial intelligence for use in a VR assistance system. The method may be repeated until the second classification output contains a number of indications of errors or malfunctions of the natural language processing of a query to the VR assistance system which is below a predetermined threshold. Further, the second classification output may contain indications of the source of the errors of the classifier, e.g. poor speech-to-text transcription. Such indications may be used to train the classifiers accordingly. The training may include training of the speech-to-text transcription algorithms and training the natural language processing algorithms either on the same data sets or on new data sets.

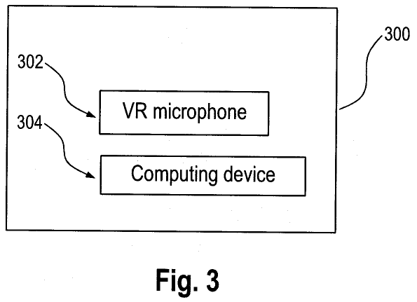

FIG. 3 depicts a block diagram of a system 300 for training one or more classifiers for use in a voice recognition, VR, assistance system. The system 300 comprises a voice recognition microphone 302 and a computing device 304. The computing device comprises an interface for a user input. The system 300 is configured to execute the methods of all above embodiments.

1. A computer-implemented method for training a classifier for use in a voice recognition (VR) assistance system, the method comprising:
collecting data which comprises one or more natural language queries to the VR assistance system;
processing the data using a natural language processing (NLP) algorithm;
generating a first classification output, based on results of the processing using the NLP algorithm;
obtaining a user input based on the first classification output; and
generating a second classification output, based on the user input, for training the classifier.

2. The method of claim 1, wherein the VR assistance system is a multi-language VR assistance system.

3. The method of claim 1, wherein processing the data using the NLP algorithm comprises processing of at least one of audio data or speech-to-text transcribed data.

4. The method of claim 1, wherein the user input comprises an indication of a malfunction of NLP classification on aspects including at least one of auditive query analysis or query content recognition.

5. The method of claim 1, wherein the user input comprises predefined labels for evaluation of the first classification output.

6. The method of claim 1, wherein the first and second classification outputs comprise one or more of:
a first natural language query from the one or more natural language queries;
language of the first natural language query;
a data set comprising data which comprises one or more of the first natural language query, a part of the first natural language query, or a response of the VR assistance system to the first natural language query;
an audio file transcript of the data set;
information about audio errors within the data set;
information about an accent of a speaker of the first natural language query;
a profile of the speaker;
classification of scope of the first natural language query; or
classification of a scope of an answer by the VR assistance system given to the first natural language query.

7. The method of any of claim 6, wherein the audio errors comprise errors regarding a wakeup word of the VR assistance system or errors regarding the first natural language query of the speaker.

8. The method of claim 1, wherein the second classification output is generated based on a compute language script.

9. A system for training a classifier for use in a voice recognition (VR) assistance system, the system comprising:
a VR microphone;
an interface for receiving a user input;
a computer-readable storage medium storing instructions; and
a processor, when executing the instructions, is configured to:
collecting data which comprises one or more natural language queries to the VR assistance system;
processing the data using a natural language processing (NLP) algorithm;
generating a first classification output, based on results of the processing using the NLP algorithm;
obtaining the user input based on the first classification output; and
generating a second classification output, based on the user input, for training the classifier.

10. A non-transitory computer-readable storage medium including instructions that, when executed by a processor, cause the processor to perform steps comprising:
collecting data which comprises one or more natural language queries to a VR assistance system;
processing the data using a natural language processing (NLP) algorithm;
generating a first classification output, based on results of the processing using the NLP algorithm;
obtaining a user input based on the first classification output; and
generating a second classification output, based on the user input, for training a classifier.

11. The system of claim 9, wherein the VR assistance system is a multi-language VR assistance system.

12. The system of claim 9, wherein processing the data using the NLP algorithm comprises processing of at least one of audio data or speech-to-text transcribed data.

13. The system of claim 9, wherein the user input comprises an indication of a malfunction of NLP classification on aspects including at least one of auditive query analysis or query content recognition.

14. The system of claim 9, wherein the user input comprises predefined labels for evaluation of the first classification output.

15. The system of claim 9, wherein the first and second classification outputs comprise one or more of:
a first natural language query from the one or more natural language queries;
language of the first natural language query;
a data set comprising data which comprises one or more of the first natural language query, a part of the first natural language query, or a response of the VR assistance system to the first natural language query;
an audio file transcript of the data set;
information about audio errors within the data set;
information about an accent of a speaker of the first natural language query;
a profile of the speaker;
classification of scope of the first natural language query; or
classification of a scope of an answer by the VR assistance system given to the first natural language query.

16. The non-transitory computer-readable storage medium of claim 10, wherein the VR assistance system is a multi-language VR assistance system.

17. The non-transitory computer-readable storage medium of claim 10, wherein processing the data using the NLP algorithm comprises processing of at least one of audio data or speech-to-text transcribed data.

18. The non-transitory computer-readable storage medium of claim 10, wherein the user input comprises an indication of a malfunction of NLP classification on aspects including at least one of auditive query analysis or query content recognition.

19. The non-transitory computer-readable storage medium of claim 10, wherein the user input comprises predefined labels for evaluation of the first classification output.

20. The non-transitory computer-readable storage medium of claim 10, wherein the first and second classification outputs comprise one or more of:
a first natural language query from the one or more natural language queries;
language of the first natural language query;
a data set comprising data which comprises one or more of the first natural language query, a part of the first natural language query, or a response of the VR assistance system to the first natural language query;
an audio file transcript of the data set;
information about audio errors within the data set;
information about an accent of a speaker of the first natural language query;
a profile of the speaker;
classification of scope of the first natural language query; or
classification of a scope of an answer by the VR assistance system given to the first natural language query.
